(19) United States
(12) Patent Application Publication
(10) Pub. No.: US 2010/0235283 A1
(43) Pub. Date: Sep. 16, 2010

(54) FINANCIAL TRANSACTIONS USING A COMMUNICATION DEVICE

(76) Inventor: Howard J. Gerson, Overland Park, KS (US)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(21) Appl. No.: 12/293,634

(22) PCT Filed: Mar. 16, 2007
(86) PCT No.: PCT/US07/64203

§ 371 Date: Sep. 19, 2008

Related U.S. Application Data
(60) Provisional application No. 60/784,245, filed on Mar. 21, 2006.

(51) Int. Cl. G06Q 20/00; H04L 9/32; G06Q 30/00; G06Q 40/00; H04M 3/42; H04L 12/66

(52) U.S. Cl. 705/75; 705/14.26; 705/17; 705/35; 705/37; 705/43; 379/201.01; 379/88.16; 370/352

(57) ABSTRACT

A computer implemented system provides a method of conducting a financial transaction. The method begins when the system assigns a designator of a value using a preauthorization by a payor. The system associates the payor with an authorized payor telephone identifier. When the system receives a telephone call with the authorized payor telephone identifier at a specified Direct Inward Dial (DID) telephone number associated with a transaction type, the system responds by sending at least one transaction code to the payor. When the system receives the transaction code from the payee, the designator of value is re-asssigned to from the payor to the payee. The system allows the transaction code to be delivered directly from the payor to the payee or sent automatically to the payee. Each DID telephone number represents different transaction types such as Automatic Teller Machine (ATM), Person-To-Person (P2P), merchant transactions, vending transactions and other types of transactions.

### FIELD OF THE INVENTION

The present invention generally relates to the field of telecommunications, and more particularly to using a telephone or other wireless handset to conduct financial transactions.

### BACKGROUND OF THE INVENTION

There are various processes used for conducting a financial transaction for the payment of goods and services between a payor and payee, also known as a beneficiary. Available payment mechanisms include cash and cash equivalents, wire transfers, ACH transfers, coupons, credit and debit cards, stored value cards, and gift cards.

E-commerce has grown rapidly with the Internet and the adoption of e-mail. Various account based systems, such as those available from PayPal and Google, let anyone with web access and an email address securely send and receive online payments using their credit card or bank account. Online systems have become an inexpensive method for merchants to accept credit cards on their on-line storefronts instead of using a traditional payment gateway.

Efforts to extend these non-traditional payment systems include turning a cell phone into an electronic wallet. One example of an electronic wallet to transfer funds by cell phone is PayPal Mobile. These payment systems enable customers to send payments over the phone via text message or by calling an automated customer service system and using voice commands.

Although various efforts to extend the use of a cell phone as an electronic wallet for financial transactions have been very useful, there are known shortcomings and problems. One shortcoming with many current systems for conducting payment with cell phones is that they require hardware and/or software modifications to retrieve and sometimes encrypt data. Hardware modifications for these types of solutions include non-contact readers such as RFID, BlueTooth, and bar code readers. Other currently available systems are based upon keycards and removable memory sticks to store account information and security mechanisms. Software modifications include specialized client applications and specialized drivers. The specialized hardware and/or software requirement means many of the millions of current cell phones in use today will not work. Accordingly, a need exists to overcome this problem.

Another shortcoming with many of the current systems for conducting payment with cell phones is that they compromise the privacy of the payee. Many currently available systems require that the payee provide personally identifiable information. To avoid this problem payees often insist on being paid by cash to remain anonymous and to avoid being associated with a given transaction. Anonymity of the payee is desirable in situations where being associated with a given type of transaction would be embarrassing. For example, purchasing weight loss products, adult diapers and alike. Accordingly, a need exists to over come this problem.

Still another shortcoming with many current systems for conducting payment with cell phones is that there is no mechanism to provide payment to a payee at an Automatic Teller Machine (ATM), unless the payee has an account on the payment system. Accordingly, a need exists to over come this problem.

Still another shortcoming with many current systems for conducting payment with cell phones is maintaining the security of transaction information such as transaction codes and PINs. Although various machine encryption techniques are being used, these require special hardware or modifications to the user's cell phone. Accordingly, a need exists to overcome this problem.

Still another shortcoming with many current systems for conducting payment with cell phones is the inability to transfer money in different national currencies. Although services such as Western Union allow money to be transferred between branches of Western Union in various countries and in different national currencies, currently, there is no mechanism to allow such transfer to occur between a payor using a telephone and a payee at an ATM.

Accordingly, what is needed is a computer-implemented system to overcome the problems encountered in the prior art and to provide a method of conducting a financial transaction using a wireless handset or cell phone.

### SUMMARY OF THE INVENTION

Disclosed is a computer implemented electronic payment system that provides a method of conducting a financial transaction. The process begins when the electronic payment system assigns a designator of a value, such as a dollar amount, using a preauthorization by a payor. The electronic payment system associates the payor with an authorized payor telephone identifier or device identifier. When the electronic payment system receives a telephone call with the authorized payor telephone identifier at a specified Direct Inward Dial (DID) telephone number associated with a transaction type, the electronic payment system responds by creating at least one transaction code. When the electronic payment system receives the transaction code and/or confirmation from the payee, the designator of value is re-assigned from the payor to the payee. The present invention allows the transaction code to be delivered directly from the payor to the payee outside the electronic payment system or sent automatically by the electronic payment system to the payee. In one embodiment, each DID telephone number represents different transaction types such as Automatic Teller Machine (ATM), Person-To-Person (P2P), merchant transactions, vending transactions and other types of transactions. In another embodiment, the various types of transactions can be selected from a single DID telephone number.

In another embodiment, the computer implemented electronic payment system provides currency conversion between a first national currency and a second currency, such as U.S. dollars to Euros.

In another embodiment, the computer implemented electronic payment system provides a transposition cipher to either the payor and/or payee. The transposition cipher is selected from a group of transposition ciphers consisting of route cipher, columnar transposition cipher, double transposition cipher, substitution cipher, and addition cipher, whereby the transaction code must be decrypted by the user prior to use without any specialized hardware.

In another embodiment, an optional private message from the payor to the payee is sent along with transaction code.

In another embodiment, a financial transaction is processed at an ATM. The method begins when a user of the ATM wishes to receive a quantity of a marketable commodity, such as cash, from a designated ATM. The electronic payment system using a Voice Over IP (VoIP) platform receives a call from a user at a specified Direct Inward Dial (DID) of the electronic payment system telephone number associated with the ATM transaction. Next, in response to the electronic payment system receiving a signal that a given transaction code has been entered by the user of the ATM, a notification message is sent over a network for the ATM to dispense the quantity of the marketable commodity in response to receiving the signal.

An advantage of the foregoing embodiments of the present invention is that a secure financial transaction is provided using a cell phone without the requirement that the payee provide personally identifiable information be provided to the electronic payment system. The present invention requires no software and/or hardware modifications so it works well with any cell phone or wireless handset or communication device.

The present invention is also advantageous because it is very scalable and works with a variety of financial transaction, including ATMs, Person-To-Person (P2P), merchant transactions, vending transactions and other types of transactions. A payor can elect to have the financial transaction server send the transaction code directly to the payee or control the transaction code by delivering to the payee outside the transaction network. The present invention works with any type of marketable commodity, especially those with a redeemable tangible medium with immediate inherent value such as cash, coupons, vouchers, stamps, tickets, tokens and points.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention will be apparent from the following detailed description taken in conjunction with the accompanying drawings in which:

FIG. 1 is a functional block diagram of an electronic payment system, including a server, in accordance with the present invention.

FIG. 2 is a generalized overview of the payor flow diagram, in accordance with the present invention.

FIG. 3 is a generalized flow diagram of payee, in accordance with the present invention.

FIG. 4 is a flow diagram of a payor and/or payee telephone identifier verification, in accordance with the present invention.

FIG. 5 is a flow diagram of a payor and/or payee PIN verification, in accordance with the present invention.

FIG. 6 is a flow diagram of a payor funding types, in accordance with the present invention.

FIG. 7 is a flow diagram of a payor and/or payee transaction code encryption, in accordance with the present invention.

FIG. 8 is a flow diagram of a payor transaction code type selection, in accordance with the present invention.

FIG. 9 is a flow diagram of a payor and/or payee delivery of transaction code, in accordance with the present invention.

FIG. 10 is a flow diagram of a payor and/or payee delivery of transaction code, in accordance with the present invention.

FIG. 11 is a flow diagram of an ATM financial transaction, in accordance with the present invention.

### DESCRIPTION OF THE PREFERRED EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

A method for authorizing payment to a payee through the use of a telephone, and an electronic payment system for implementing the method, is described as follows. A payor, using a telephone or other communication device, calls a pre-determined telephone number or predetermined IP address to access an electronic payment system. The payor calls either a general telephone number of the electronic payment system or a telephone number that is specifically associated with a payee or payor.

Overall Electronic Payment System

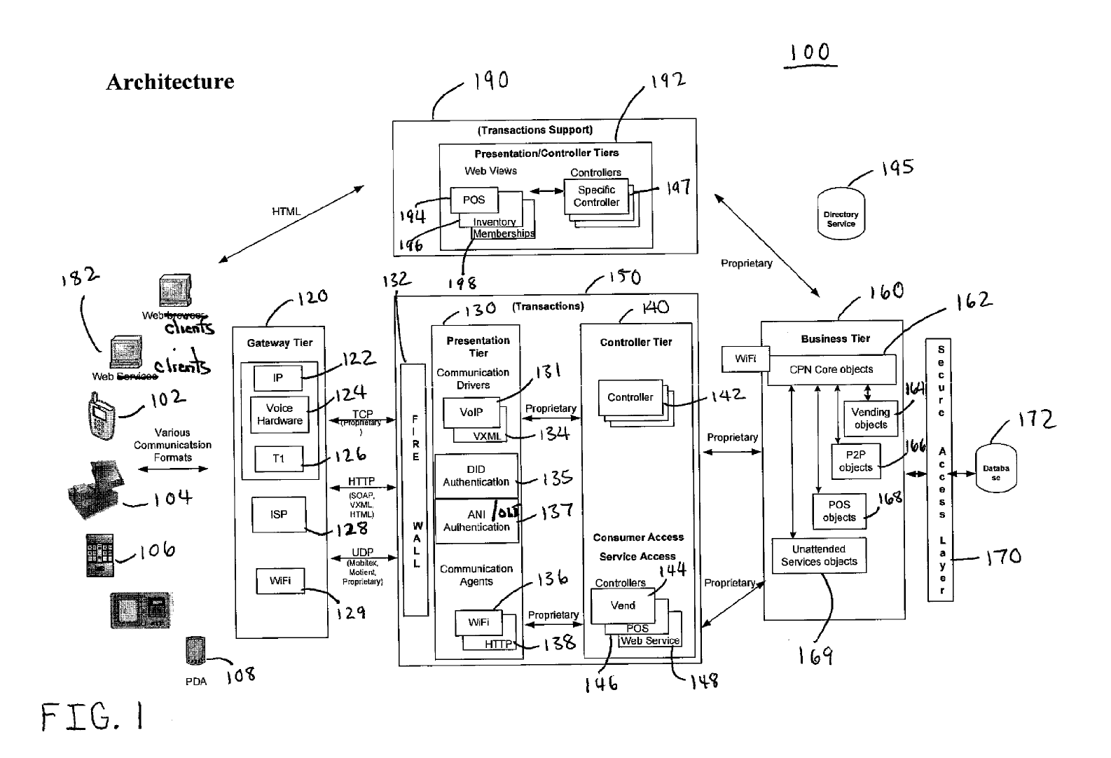

FIG. 1 is a functional block diagram of an electronic payment system 100, in accordance with the invention. The electronic payment system has a different clients cell phone or wireless handset 102, Point Of Sale (POS) terminal 104, computer 106 and Personal Digital Assistant (PDA) 108 that communicates with Gateway Tier 120. Communications with the gateway tier are through any communication network including SS7 protocol over terrestrial, satellite, wired, wireless in a manner known to those of average skill in the art. Gateway tier 120 includes communication interfaces to IP (Internet Protocol) 122, voice 124, data connection such as T1 126, Internet Service Provider (ISP), 128 and Wireless Fidelity (WiFi) 129 and others. The communication gateway 120 communicates using a variety of protocols TCP, HTTP, UDP to a fire wall 132 in the Financial Transaction Server 150. Logically the Financial Transaction Server 150 is broken into two halves: a presentation tier 130 and control tier 140, that communicate to each other over wired and wireless protocols e.g. VoIP 131, VXML 134, WiFi 136, and HTTP 138. Also included in the presentation tier 130 is DID (Direct Inward Dial) agent 135 and payor telephone identifier such as ANI (Automatic Number Identifier) agent 137 or OLI (Originating Line Identifier) agent or SS7 signaling component or device identifier such as IP address or identifier of the payor such as biometric identifier such as voice recognition.

The controller tier 140 has different consumer control modules that interact with various business infrastructures in business tier 160. Likewise, the controller tier includes various service controllers for vending 144, Point Of Sale (POS) 146, Web Services 148 that communicate with various business objects: vending objects 164, P2P objects 166, POS objects 168, and unattended service objects 169 such as an ATM object. A secure access layer 170 with a database 172 is coupled to the business tier 160 for use by the electronic payment system 100.

In the electronic payment system 100, a transaction support layer subsystem 190 provides accounting, financial, reporting and administrative access through web clients 182. Modules such as POS 194, Inventory 196, and Membership 198 along with their attendant controllers 197 are shown. A directory database 195 is also coupled to the electronic payment system 100. It is important to note, that storage devices other than databases 172 and 195 can be used for connections to mass storage devices, which may be used to store and read data.

Although electronic payment system 100 is illustrated as separate subsystems with multiple CPUs, a single system can be used equally effectively. Although the exemplary embodiments of the present invention are described in the context of a fully functional computer system, those skilled in the art will appreciate that embodiments are capable of being distributed as a program product via floppy disk, e.g., CD ROM, or other form of recordable media, or via any type of electronic transmission mechanism.

Generalized Overview of Process

The electronic payment system 100 includes a server programmed to perform steps in accordance with the invention. A payor, using a phone, calls a specified telephone number to access an electronic payment system. The payor calls either a generic telephone number for the electronic payment system or a special telephone number that is associated with the payee to be paid and/or with the payor. The specialized telephone number, such as a Direct Inward Dial (DID) number may be assigned to a specific payee such as a chain of banks, stores or restaurants. The specialized telephone number may be assigned to a specific payor and/or payee based on certain affiliations such as airline miles, memberships to specific organizations, or the frequency of use of the electronic payment system 100.

The electronic payment system identifies the payor by the calling phone's telephone number, as identified by an authorized payor telephone identifier typically generated by a carrier such as Automatic Number Identification (“ANI” or “Caller ID”) and OLI (Originating Line Identifier). The payor, in response to voice prompts, enters his or her Personal Identification Number (PIN) and a payment amount by using the phone keypad. The electronic payment system validates the payor's PIN and verifies that sufficient funds are in the payor's account to cover the payment amount. The electronic payment system then authorizes the payment to the payee.

The payee is identified either by the special telephone number that is called by the payor to select payment to that payee, as described above, or by the payor calling the generic telephone number for the electronic payment system and entering an identifier of the payee, such as the payee's telephone number or other identification number, from his or her telephone keypad in response to a voice prompt.

Payment to the payee is then able to be completed either immediately after the entry of data by the payor or after a request for payment is made by the payee. In some embodiments, the electronic payment system provides the payor a transaction code, or codes, such as a transaction alphanumeric sequence, that is associated with the payment. This multi-digit transaction code is given during the phone call through text message, voice message, e-mail message, fax, telegram, and postal letter, typically after the payment is authorized. In one embodiment, the transaction code is only valid for one use and is only valid for a specified period of time. In order to complete the transaction in the embodiment where the electronic payment system provides such a code to the payor, the payor gives the payee the transaction code and the payee submits an invoice amount and the transaction code to the electronic payment system. Once the electronic payment system receives this transaction code and the invoice amount, the funds are transferred from the payor's account to the payee's account. A variation of this electronic payment system allows the payor to obtain a transaction code for a maximum payment amount to a specified payee, such as a particular merchant. This transaction code is valid for a specified time period, allowing the payor to shop at that merchant and present the code at checkout in order to effect payment for the purchases.

In addition to providing payment to a payee, the electronic payment system of the present invention is used to cause an Automatic Teller Machine (ATM) to dispense money to the user of the phone. In such electronic payment system, the user calls a telephone number associated with a particular ATM and/or a generic number associated with a given ATM network, enters a cash amount and his or her PIN through the telephone, and the ATM will dispense the specified amount of cash upon verification of the PIN and account balance for the account associated with the phone number of the phone making the call. It is important to note that the payee or recipient of the cash or other marketable commodity in one embodiment does not have to enter information into the keypad at the ATM. In another embodiment, the payee enters information into the keypad at the ATM, such as the payee's telephone number, PIN, or transaction code.

The financial electronic payment system 100 enables the full cycle of a payment transaction between two parties. The two parties may include:
Customer to Merchant
Merchant to Customer
Customer to Customer
Business to Vendor
Vendor to Business
Customer to Third Party

The purpose of this transaction may be for any of the following reasons:
Payment for goods
Payment for services
Credit for goods
Credit for services
Gift
Account to account transfer
Stored value
Draw down on line of credit
Domestic funds transfer
International funds transfer
Currency Exchange

The following flow diagrams illustrate three different examples:
1) Paying with a wireless telephone: person-to-person (P2P) using a wireless telephone.
2) Paying/Withdrawing with a wireless telephone: to get money out of an ATM.
3) Redemption/Paying/Withdrawing with a wireless telephone: merchant Point Of Sale terminal (POS).
4) Paying with a wireless telephone: service, e.g., restaurant (REST).

Overview of Payor

The following flow is nearly identically for the different types of payment services available from the electronic payment system 100 i.e. P2P, ATM, Restaurant and POS. The

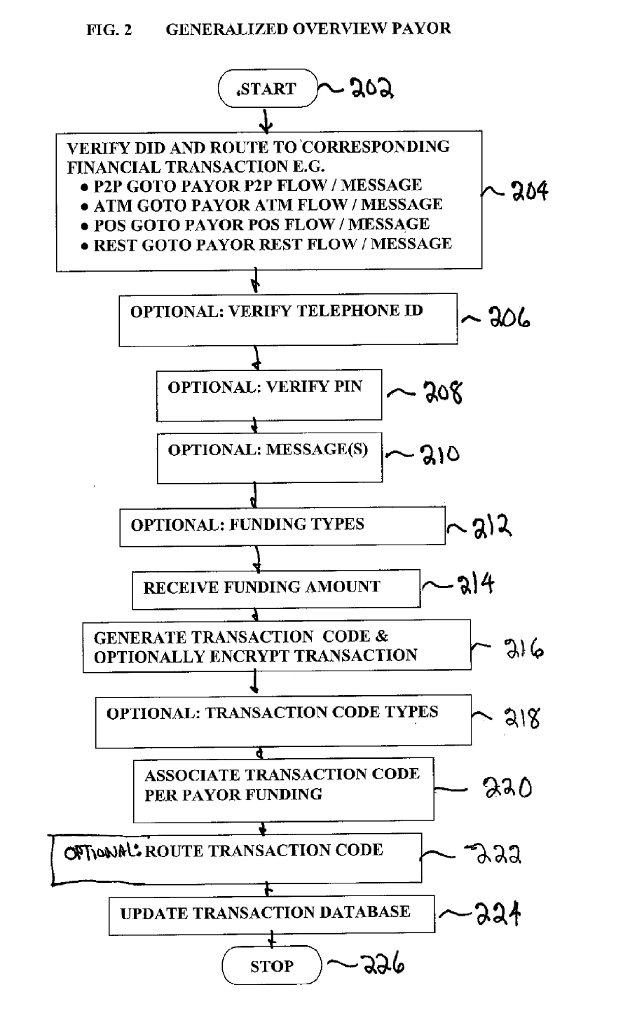

FIG. 2 is a generalized overview of the payor flow diagram, in accordance with the present invention. The process starts 202 and proceeds directly to step 204 with a payor initiating a call to electronic payment system 100. The DID called in one embodiment defines the type of transaction that will be handle, for example P2P, ATM, POS, and RES. It is important to note that for the type of financial transaction e.g. P2P, ATM, POS, and RES, in some embodiments provide different types of authorizations for funding. For example, in an ATM or P2P transaction, the exact amount of the transaction is known by the payor when initiating the funding or transfer. However in some RES transactions and POS transaction the exact amount may not be known until the payor has calculated a service tip or until after all the items for purchase have been scanned and total presented to the payor at store. Accordingly, in the RES and POS transaction types an estimated preauthorization or a not to exceed amount of funding for the transaction captured for this type of financial transaction as opposed to an exact amount.

Further, depending on the transaction type, the electronic payment system 100 will capture the telephone number or other identifier of the payee. For example in a P2P transaction type, the payor would enter the payee's telephone number. Whereas for POS, Vending or other types of financial transactions associated with a specific DID, there is no need to identify the payee because the DID is associated with the payee.

Optional: Payor Telephone Identifier and PIN

Optionally the electronic payment system 100 in step 206 receives the authorize payor telephone identifier. In one embodiment, a payor's PIN (Personal Identification Number) is also received in step 208. Depending on the financial transaction type or the preferences set by the individual payor, system voice prompt and messages 210 are played such as current balance, last activity, new account setup and other account management messages.

Optional: Payor Funding

In step 212, optional different types of funding are prompted such as financial account at a bank, a redemption account, a stored value account, a credit card account, a gift card account, a prepaid telephone account, and a debit card account. An option balance verification or message is given to notify the payor of the available funds.

Receive Amount From Payor

In step 214, the electronic payment system 100 prompts the payor for a designator of value such as a numerical number or code representing the amount of cash, points, coupons, tickets, tokens, and other redeemable tangible medium with immediate inherent value. Verification of the numerical designator is completed and the available funds depending on the optional funding type step 212 are checked. It is important to note that the funds may be transferred from a financial account, redemption account, a stored value account, a gift cards account, a credit card account, a debit card account and any other funding mechanism that can be associated with a payor. In one embodiment where there are insufficient funds available, a failure message is played such as The Amount Requested Exceeds The Limit In The Account” or Your Transaction Exceeds The Allowable Value For This Transaction Type.” The system in one embodiment limits the amount of marketable commodity that can be transferred depending on such factors as financial transaction type. For example, one limit may be applied for POS and another limit applied to ATM transactions. Other factors such as usage history with the system of payor and/or payee of the system.

Generate Transaction Code & Optional Encryption

A transaction code is created which is associated with the payor, the funding type, the funding amount and the payee. The transaction code is any random code of any length which may include alpha-numeric digits. In step 216, depending on the payor's and/or payee's profile encryption of the transaction code occurs. The encryption is of the type that can be mentally decrypted by the recipient without the need to use hardware or software. A transposition cipher changes one character from a plaintext transaction code to another. To decrypt, the reverse is done. For example is the original transaction code is 459220, the encryption may be to swap two digits like the last two digits rendering 459202. Or the encryption may be to add the number 100 to any transaction code where the original transaction code is 459220 and the encrypted code is 459320. Again, although the encryption process is performed automatically as set by optional preferences of the payor and/or payee, the decryption process is done mentally to avoid the need of specialized hardware and software. Any transposition cipher can be used including those selected from a group of transposition ciphers consisting of route transposition cipher, columnar transposition cipher, double transposition cipher, substitution cipher, and addition cipher, whereby prior to use by the payee, the transaction code must be decrypted. For further information on transposition cipher refer to (http://en.wikipedia.org/wiki/Transposition_cipher#Route_cipher) which is hereby incorporated by reference in its entirety.

Optional: Transaction Code Types

In optional step 218, the transaction code may have conditions associate with it for example for additional security the transaction code may be linked to only a given type of payee e.g. RES, ATM, POS or a given type of store, merchant, class of good e.g., groceries, consumer electronics, clothing, and other categories of spending. In another embodiment, the transaction code is valid for a period of time before expiring. Further, the transaction code may be for a set amount i.e. a preauthorized amount e.g. ATM, P2P or a not to exceed amount RES, POS. The use of not-to-exceed amount transaction codes, allow additional charges such as service tips and gratuities to be added.

Associate Transaction Code with Payor Funding

In step 220, the transaction code is associated with the payor's funding set in step 212 e.g. financial account at a bank, a redemption account, a stored value account, a credit card account, a gift card account, and a debit card account.

Optional Route Transaction Code

Next in step 222, the transaction code is routed to the payor and/or payee depending on the payor and/or payee preferences along with the type of financial transaction. For example a text message, voice message, e-mail message, fax, telegram, and postal letter is routed to the payor and/or payee. For example, in a P2P, the system in one embodiment, does not provide a transaction code to either of the payor or the payee. However, in other financial transaction types such as RES, POS, the system provides a transaction code to the payor and/or payee.

Optional: Currency Conversion Embodiment

In the embodiment for the ATM or P2P, there may be an intermediate currency conversion from one national currency to a second national currency, such as from U.S. Dollars to Mexican Pesos. The electronic payment system 100 prompts for the type of currency that is to be purchased. Alternately, the type of currency in one embodiment is based on the funding account type i.e. payor always pays in U.S. dollars off a bank account and this particular payee receives Canadian dollars. In still another embodiment, the telephone number of the payor and/or payee maybe used to determine the national currency. The electronic payment system would then use international currency conversions, such as those available at most banks, to correctly calculate the exchange rate.

Optional: Loyalty Rewards Embodiment

In an optional embodiment not shown, the electronic payment system 100 gathers transaction and merchant data. This data is then used to provide loyalty incentives to the consumer. The Merchant will determine the loyalty rewards. The parameters for determining the rewards may be, frequency, amount spent within a certain period, product specific purchases, random selection or contest specific.

Overview of Payee

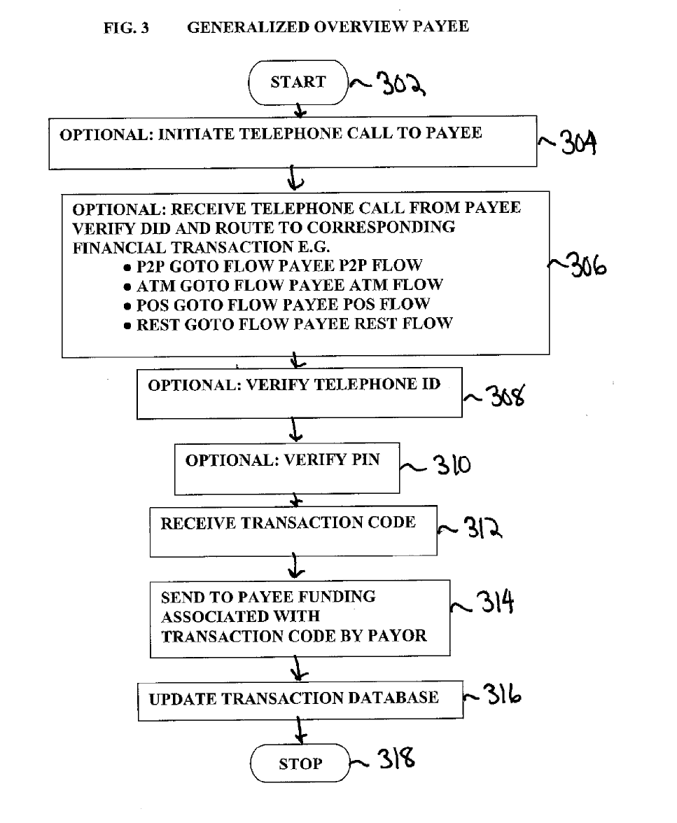

FIG. 3 is a generalized flow diagram of payee, in accordance with the present invention. Not shown, but understood for those of average skill in the art, in the case where the payee is not registered with the electronic payment system 100, prompts are played to register the payee and to capture payee information and to setup an account and PIN.

The process begins at step 302 and immediately proceeds to an optional step 304 where the electronic payment system 100 calls the payee.

Optional: System Contacts Payee

This optional step in one embodiment is for financial transactions types such as P2P and ATM, whereas typically for the financial transaction types of POS and RES, the electronic payment system communicates over a data link such as the internet. Having the electronic payment system 100 call a predetermined telephone number of a payee provides for greater end-to-end security and reduces the possibility of fraud. For example optionally the electronic payment system 100 initiates a call to the payee's telephone announcing that the money is available to payee.

Optional: Payee Contacts System

The process continues with an optional step 306 where the payee contacts the electronic payment system 100. Financial transactions types such as RES and POS would typically initiate the communication with the electronic payment system 100.

Optional: Payee Telephone Identifier and PIN

Along with this optional step 306, the electronic payment system verifies the payee telephone identifier such as ANI, OLI or other telephone identifier typically generated by the carrier. In step 310, an optional PIN from payee is captured.

Transaction Code Received

Next, the payee enters the transaction code and/or confirmation such as a keypad entry. It is important to note that the payee in one embodiment receives the transaction code directly from the electronic payment system 100 such as through text message, voice message, e-mail message, fax, telegram, and postal letter. In another embodiment, the payor sends the payee the transaction code outside the electronic payment system 100.

Re-Assign Designator of Value

Next the electronic payment system 100, in response to receiving the correct transaction code, the electronic payment system re-assigns the designator of value such as an amount of cash, to the payee's accounts. In a POS or RES embodiment, the designator of value is transferred to the store or restaurant. It is important to note, that in one embodiment for the POS or RES financial transaction, that the identity of the payor is anonymous to the store or restaurant since only the transaction code is provided from the payor to the payee. No personally identifiable information is given to the merchant or restaurant.

In the embodiment for the ATM or P2P, there may be an intermediate currency conversion from one national currency to another, such as from U.S. Dollars to Mexican Pesos. Further, in the ATM financial transaction, the cash may be immediately dispensed from the ATM machine. The re-assigning the designator of value is from the payor's account directly to the ATM network.

Regardless of the financial transaction type, a database updating the re-assignment of the designator of value, such as an amount of cash, points, coupons, vouchers, stamps, tickets, tokens, points or other redeemable tangible medium with immediate inherent value is recorded in the database 172.

Optional: Payor/Payee Telephone Identifier Verification

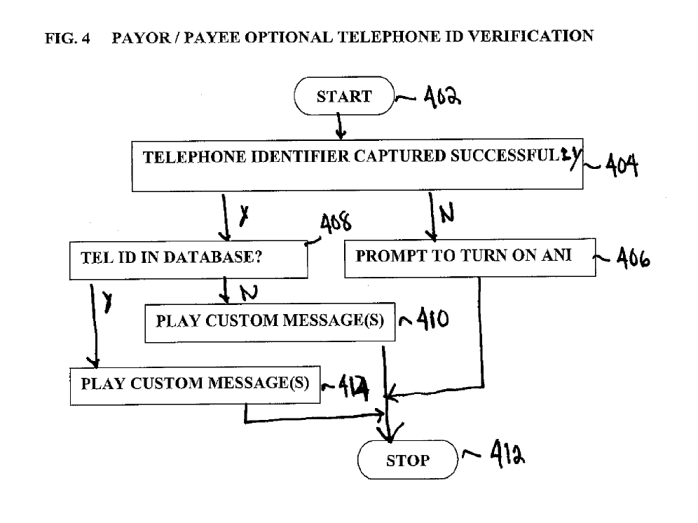

FIG. 4 is a flow diagram of a payor and/or payee telephone identifier verification, in accordance with the present invention. This process flow provides an embodiment for steps or acts 206 of FIGS. 2 and 308 of FIG. 3. The process begins at step 402 and immediately proceeds to step 404 where a determination is made if the telephone identifier of the payor and/or the payee was successfully captured. In the case where the telephone identifier was not successfully captured, an additional authorization code may be request to properly identify the payor. In some national phone systems, additional digits, padding or translation may be necessary to provide the correct authorization to the system and identify the county of origin. Or in another embodiment a prompt is played to turn on the caller-id or to unblock the caller id of the telephone in step 406 and the process ends at step 412. In the case the telephone identifier is captured, a check is made to see if the telephone identifier is authorized in a database. Depending on whether telephone identifier is in a database, one or more custom messages are played to the caller such as “Welcome To Phone1 Pay System”, in step 414 and the process ends at step 412. In the case where the telephone identifier is not in the database, a different custom message(s) in step 410 are played such as “Not Registered With The System” and the process ends at step 412.

Optional: Payor/Payee PIN Verification

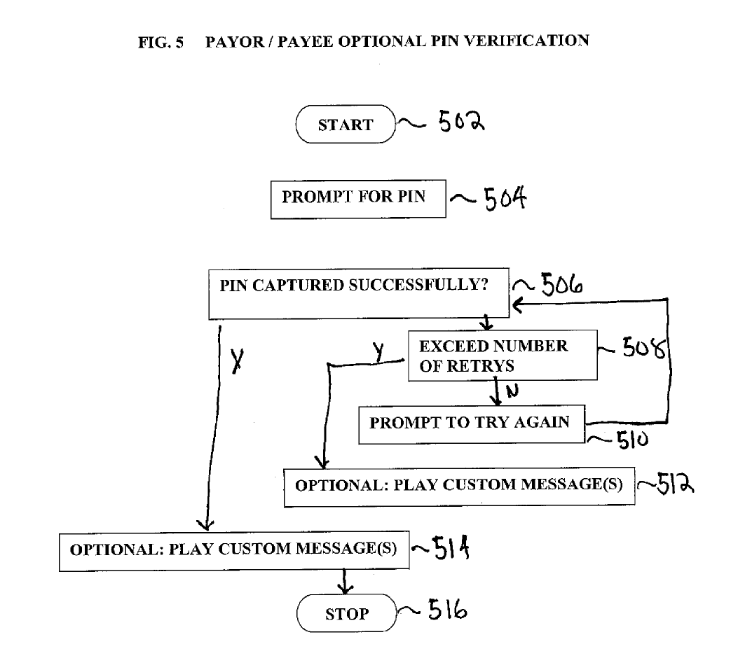

FIG. 5 is a flow diagram of a payor and/or payee PIN verification, in accordance with the present invention. This process flow provides an embodiment for steps or acts 208 of FIGS. 2 and 310 of FIG. 3. The process begins at step 502 and immediately proceeds to step 504 where a prompt is played to enter the PIN (Personal Identifier Number). A determination is made if the PIN of the payor and/or the payee was successfully captured in step 506. In the case where the PIN was not successfully captured, a test is made in step 508 to determine if a predetermined number of failed attempts have occurred. If the number of attempts is below the predetermined number a prompt to try again is played in step 510 and the flow returns to step 506. It is important to note, that after a predetermined number of failed attempts, the flow plays an optional message such as For Security Reasons This Account Has Been Locked. Please Contact Consumer Service” and the account is locked (not shown) before the flow terminates in step 516. In the event the PIN captured matches a stored value for the user, the electronic payment system s 100 plays optional messages 516 such as “Welcome To Phone1 Pay System” and the process ends in step 516.

Optional: Funding Types

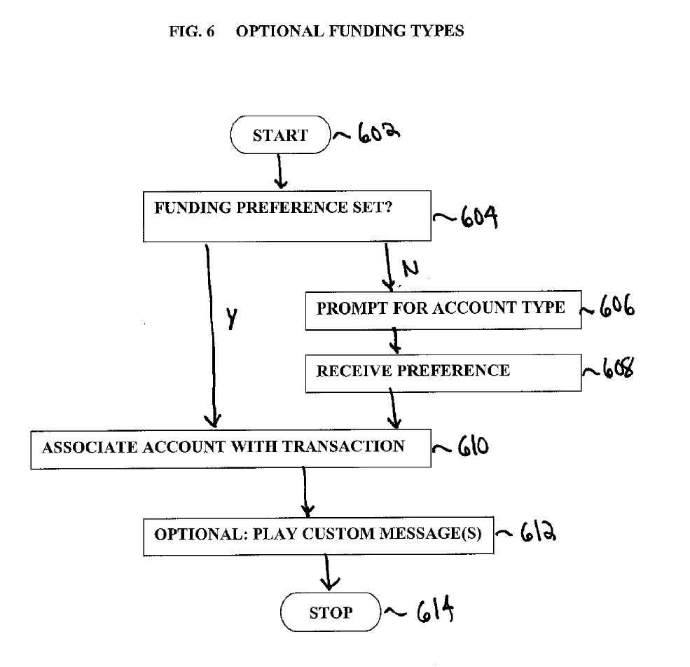

FIG. 6 is a flow diagram of a payor funding types, in accordance with the present invention. This process flow provides an embodiment for step or act 212 of FIG. 2. The process begins at step 602 and immediately proceeds to step 604 where a determination is made if the payor's funding preference is set. In the case where the funding transaction is not set, a prompt is played to select a type of funding preference from an available funding sources such as a bank account, a redemption account, a stored value account, a credit card account, a gift card account, and a debit card account, in step 606. The preference is received in step 608 and the transaction is associated with an account type in step 610. In the case where the funding preference is already set, the process flow directly from step 604 to step 610. Optional custom messages are played in step 612 and the process terminates in step 614.

Optional: Encryption of Transaction Code

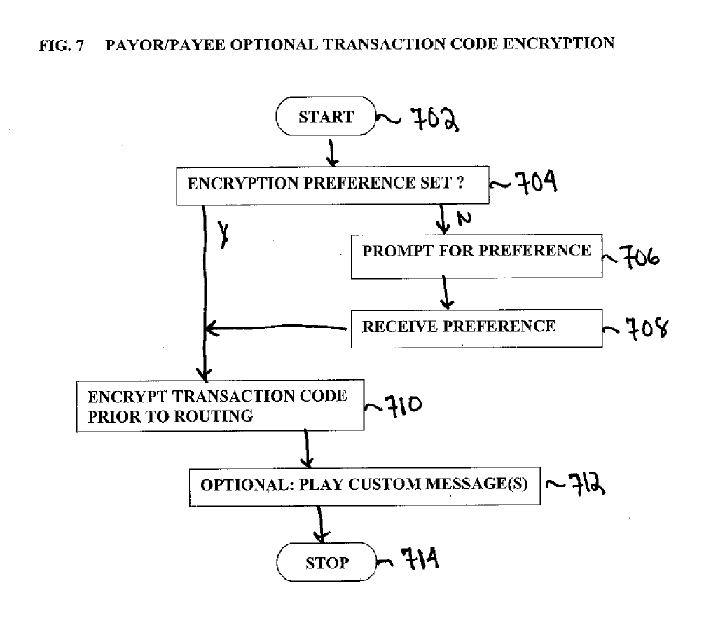

FIG. 7 is a flow diagram of a payor and/or payee's transaction code encryption, in accordance with the present invention. This process flow provides an embodiment for step or act 216 of FIG. 2. The process begins at step 702 and immediately proceeds to step 704 where a determination is made if the payor's and/or payee's transaction code encryption funding preference is set. In the case where the encryption code is not set, a prompt is played to select a type of encryption preference in step 706 and the preference receive in step 708 and proceeds to encrypting the transaction code in step 710 prior to sending. In the case where the encryption preference is already set, the process continues to step 710 to encrypt the transaction code according to the set preferences. Next in step 712, one or more optional messages are played confirming the encryption cipher used and the process terminates in step 714.

Optional: Transaction Code Type

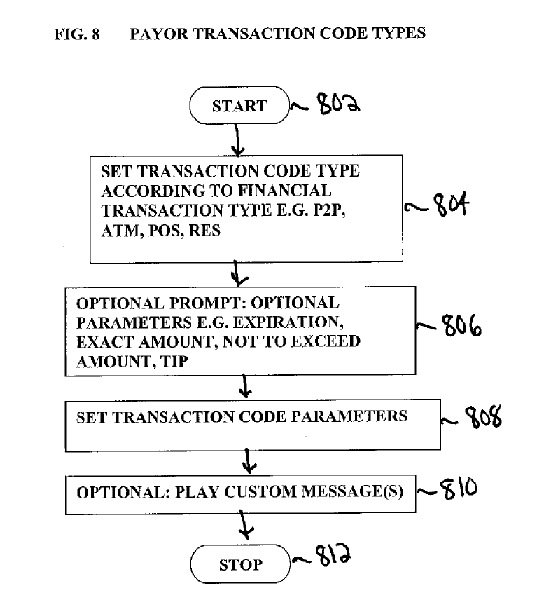

FIG. 8 is a flow diagram of a payor transaction code type selection, in accordance with the present invention. This process flow provides an embodiment for step or act 218 of FIG. 2. The process begins at step 802 and immediately proceeds to step 804 where a the transaction code type such as expiration, use for only a given good, service, store, bank is set depending on the financial transaction type and preferences of the payor and/or payee in step 806. The system provides an optional prompt in step 806 to allow the payor to set additional parameters, conditions and limitations associated with the transaction code. For example, the transaction code may be limited to a certain dollar amount, or a user definable expiration period. In step 808 the transaction code parameters are set in the system based upon a combination of the financial transaction types of step 804 and the user preferences captured in step 808. Optional custom messages are played to the user confirming the transaction code type that has been set. The process terminates in step 812.

Optional: Route Transaction Code

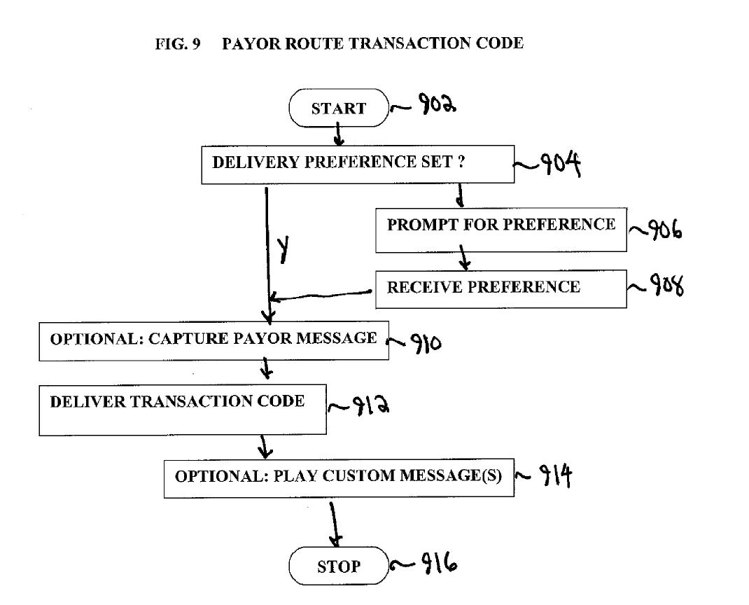

FIG. 9 is a flow diagram of a payor and/or payee delivery of transaction code, in accordance with the present invention. This process flow provides an embodiment for step or act 222 of FIG. 2. The process begins at step 902 and immediately proceeds to step 904 where a determination is made if the payor's and/or payee's routing preference for the transaction is set. In the case where the routing preference is not set, a prompt is played to select a type of routing or default is used in step 906 and the preference receive in step 908 and the process proceeds to capture payor's optional message in step 910. Routing preferences include text message, voice message, e-mail message, fax, telegram, and postal letter. In one embodiment, the payor can over-ride any preference option of the payee. In the case where the routing preference is set, the flow continues directly to step 910 where the optional payor's message is captured. This may be a recorded voice message e.g. “Jim Your Payment Has Been Setup. Please Proceed To Any First Bank ATM.” The payor can re-record the message or save it and verifies the message before exiting. At this point a designator of value for the specific payor and a telephone number of a payee is recorded in that database 172. The transaction code is delivered according to the preferences set for the payor and/or the payee. It is important to note that the payor may decide to provide the transaction code directly to the payee outside the electronic payment system 100. In another embodiment, besides sending the transaction code to the payor, the electronic payment system sends the transaction code to the payee in a manner specified e.g. text message, voice message, e-mail message, fax, telegram, and postal letter along with any optional message. The process continues with any optional systems messages 914 being played and the process terminates in step 916. It should be understood that using a P2P transaction in the present invention, a merchant as a payee would be able to receive payment with just a telephone and without the need of any POS platform.

Example of P2P Transaction

Now with reference to figures above, described is one embodiment where a payor wishes to send a marketable commodity to a payee. The payor initiates a telephone call to a predetermined DID telephone number for a P2P financial transaction. After the electronic payment system verifies a payor's telephone identifier and PIN, optional prompts such as “Please Enter the Recipients Telephone Number Including Area Code”. A check is made to determine if the payee/recipient is previously registered with the electronic payment system and a warning played if the payee has not been previously setup. The payor selects a funding type such as a bank and enters a numerical value for a marketable commodity such as cash. The electronic payment system provides a transaction code to the payor and the electronic payment system updates it records that a transaction is pending. The payor in this example decides to give the transaction code directly to the payee without using the electronic payment system to automatically send the code. The payee receives the transaction code from the payor. The electronic payment system calls the payee at the telephone number stored. When the payee answers the call from the electronic payment system, in one embodiment the payee enters a PIN and a transaction code. In another embodiment, the payee may not need to enter either the PIN and/or transaction code or both, the payee only needs to confirm with a keypad response that they received the call. This type of feedback ensures that the system delivered the message and the payee confirmed receiving the information. The electronic payment system moves the amount of marketable commodity from the payor's funding account to the payee's account.

Example of Point Of Sale Terminal (POS)

Continuing with reference to figures above, described is one embodiment where a payor wishes to pay for a sale at a POS. This provides secure and anonymous payment at a retail location. The merchant needs an existing POS platform. The merchant's POS must be connected to either a telephone line or an Internet connection. For any merchant that accepts credit cards currently, these requirements are already met.

The final requirement for implementation is that a software application protocol interface (API) in accordance with the invention needs to be downloaded to the POS terminal. The API enables the merchant to close the transaction, and provides the necessary settlement and reporting. The API is small and fully compatible with the merchant's existing system.

The payor/customer uses a wireless telephone/PDA to connect to the electronic payment system prior to shopping or at the store. The electronic payment system authenticates and validates the payor and the amount of funds available. The electronic payment system issues a multi-digit transaction code to the payor/customer. The customer shops at the retail location. At the end of a period of shopping, the customer proceeds to the checkout. The merchant totals the items purchased. The payor/customer then tells the merchant the transaction code for this transaction or directly enters the code into the POS itself. The POS sends the transaction code and the order total to the electronic payment system for authorization. The electronic payment system receives the transaction and validates the availability of funds for the order total and validates the transaction code. The electronic payment system returns to the merchant's POS an approval status. The transaction is now complete. In this example, the transaction code type is only good for a single transaction at a specific store and cannot be reused during the next seventy-two (72) hours. Also it is important to note, that although the example has been described for the purchase of a good using a POS, the purchasing of services, such as automotive repair, is within the true scope and spirit of the present invention.

Example of Vending Machine (VEND)

Continuing with reference to figures above, described is one embodiment where a payor wishes to pay for a sale at a vending machine, such as a soda machine, candy machine, airport luggage cart; washing machine, parking meter, parking garage, elevator, and any other unattended mechanism that dispenses a good or performs a service or provide access to a good and/or service. This provides secure and anonymous payment for vending transactions. The vending machine must be connected to either a telephone line or an Internet connection. For any vending machine that accepts credit cards currently, these requirements are already met.

The payor/customer uses a wireless telephone/PDA to connect to the electronic payment system using a number associate with a specific vending machine or vending company. The electronic payment system authenticates and validates the payor and the amount of funds available. The payor enters the item desired and optionally the amount for the item or service. The electronic payment system issues a secure packet to the vending machine to dispense the item or service selected. The financial payment system reconciles accounting with the vending machine systems. The transaction is now complete. In this example, the transaction code generated by the financial transaction system for internal accounting purposes may be only good for a single transaction at a specific store or vending machine and cannot be reused during the next period of time.

Example of Restaurant (RES)

Now with reference to figures above, described is one embodiment where a payor wishes to send a marketable commodity to a Restaurant (RES). Like the POS transaction type, secure and anonymous payment at a restaurant is accomplished. The restaurant needs an existing system that accepts non-cash payments such as a credit cards. The restaurant system must be connected to either a telephone line or an Internet connection. The final requirement for implementation is that a software application protocol interface (API) in accordance with the invention needs to be downloaded to the restaurants platform. The API enables the restaurant to close the transaction, and provides the necessary settlement and reporting. The API is small and fully compatible with the restaurant's existing system.

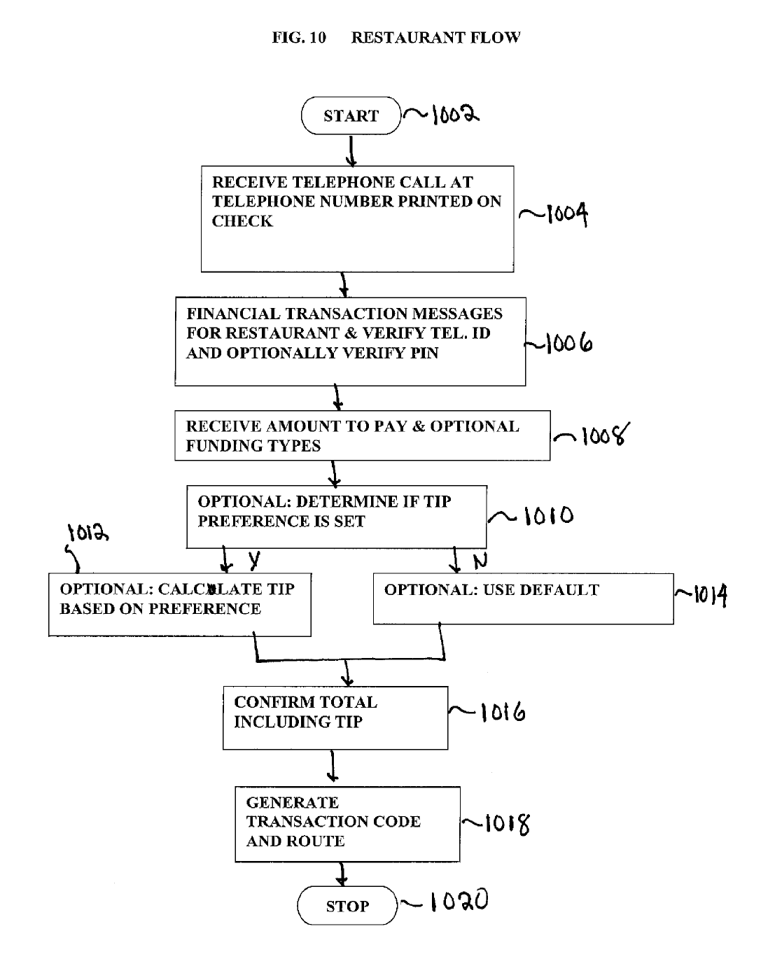

When a check or tab is presented to the customer, in one embodiment, the check includes a telephone number or DID for the payor/customer to use when rendering payment using the present invention. Turning now to FIG. 10, shown is a flow diagram of a payor and/or payee delivery of transaction code, in accordance with the present invention. The process begins at step 1002 and immediately proceeds to step 1004 when the payor/customer uses a wireless telephone/PDA to connect to the electronic payment system 100. As explained in the figures above, the electronic payment system 100 in step 1006 authenticates and validates the payor and the amount of funds available. In one embodiment, the telephone number called has been previously associated with the restaurant. In another embodiment, the payor/customer must select the restaurant from an interactive voice menu. Once the restaurant is selected the amount of the bill, check or tab is sent to the electronic payment system in step 1008.

In one embodiment, the electronic payment system using the previously stored preferences for the payor/payee calculates a tip in step 1010. The tip calculator application runs using a pre-established entry in the database, and yet allows full payor/customer override. The payor/customer has the option to establish a profile with the electronic payment system. The profile shortens the time and prompts for the customer during the customer's use of the electronic payment system. For example, the customer may have pre-established that the customer would prefer to leave an 18% tip by default. The 18% entry is made in a tip percent field of the database. The tip calculator application looks in the tip percent field prior to making a tip calculation in step 1012. In one embodiment, if no entry is made in the tip percent field, a default such as 15% is used but other defaults are definable in step 1014. In either case, the payor/customer has an opportunity to override the suggested amount and input a different amount. In another embodiment, the interactive voice response system prompts for a gratuity or tip.

A total payment that includes and optional tip is verified by the payor/payee in step 1016 and a transaction code is sent to the payor/customer in step 1018. The payor/customer then tells the restaurant the transaction code for this transaction. In one embodiment, a total payment is also provided to the restaurant along with the transaction code to help the restaurant identify the amount of gratuity. The restaurant system sends the transaction code and the total to the electronic payment system for authorization. The electronic payment system receives the transaction and validates the availability of funds for the total and validates the transaction code. The electronic payment system returns to the restaurant an approval status. The transaction is now complete in step 1020.

Example of ATM Transaction

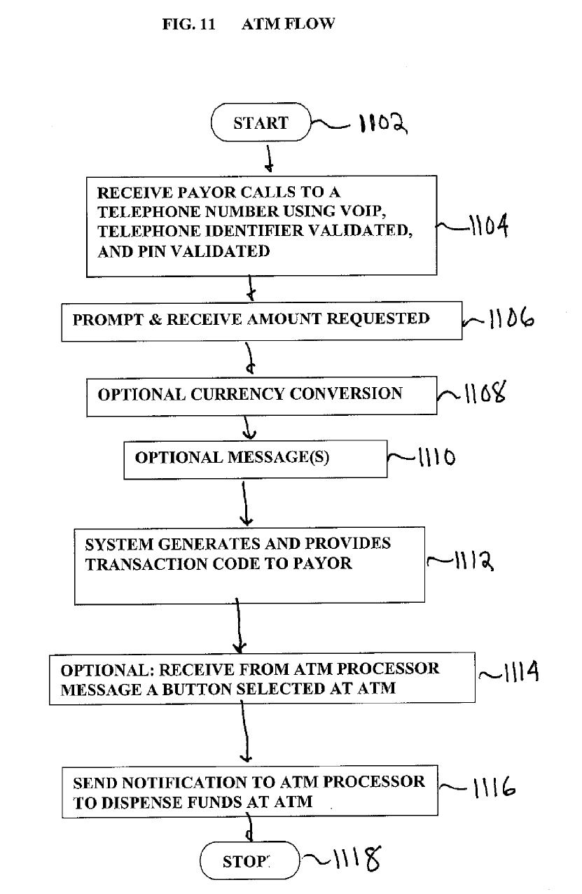

Again with reference to figures above, described is one embodiment of a cardless ATM transaction where a payor sends a marketable commodity to a payee using an ATM with an example of currency conversion. FIG. 11 is a flow diagram of an ATM financial transaction for this example. The process begins in step 1102 and immediately proceeds to step 1104. Once the payor is authenticated and validated in step 1104, the payor enters the amount of marketable commodity in step 1106. In an optional currency conversion step 1108, the electronic payment system determines if the payor's account and the ATM are in the same country. The electronic payment system converts the funds requested from the payor's account into the currency of the ATM. For example, a U.S. Bank Account being used in Europe would dispense EUROS. It is important to note that in this example the payor and payee are the same person. However in other embodiments, the payor and payee are different account holders.

Next, optional messages 1110 are played. The electronic payment system generates a transaction code and routes it to the payor via any one or more routes of a text message, a voice message, an e-mail message, a fax, a telegram, and a postal letter. The payor or if the transaction information is given to a payee the payee, standing in front of the ATM machine the funds or marketable commodity is dispensed. In one embodiment the cash is immediately dispensed at the ATM without the payee entering anything at the keyboard at the ATM or using any card with the ATM. In another embodiment, a PIN and/or transaction code is entered at the keyboard at the ATM without using a bank card. The electronic payment system receives a message from the ATM processor that a key or keys were entered on the ATM in step 1114. The keys entered may include the transaction code. In step 1116, the electronic payment system sends a notification message to the ATM processor to dispense the funds or marketable commodity at the ATM machine and the process ends at step 1118. The electronic payment system itemizes and logs the transaction in the database.

Non-Limiting Examples

Although the customer referred to herein is typically a natural person who is a retail consumer, it should be understood that the scope of the claims is not limited to a natural person who is a retail consumer; rather, the customer can be any type of entity or user.

Although the merchant referred to herein is typically a business that is a retailer that sells goods or services, it should be understood that the scope of the claims is limited to a business that is a retailer that sells goods or services; rather, the merchant can be any type of entity or user.

Although a specific embodiment of the invention has been disclosed, it will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. A computer-implemented method of conducting a financial transaction, the method on a financial transaction server comprising:
assigning, using a preauthorization by a payor associated with an authorized payor telephone identifier, a designator of a value for a subsequent transaction between the payor and at least one payee;
receiving at a specified Direct Inward Dial (DID) telephone number associated with a transaction type a telephone call with the authorized payor telephone identifier;
in response to receiving the telephone call, sending at least one transaction code to the payor; receiving from the payee the transaction code; and
in response to receiving the transaction code, re-assigning the designator of the value to the payee.

2. The computer-implemented method of claim 1, wherein the receiving from the payee the transaction code, includes receiving the transaction code that was transferred directly from the payor to the payee without using the financial transaction server.

3. The computer-implemented method of claim 1, further comprising:
automatically sending the transaction code to the payee through at least one of:
a text message;
a voice message;
an e-mail message;
a fax;
a telegram; and
a postal letter.

4. The computer-implemented method of claim 1, wherein the designator of the value to be re-assigned from the payor to the payee is associated with at least one of:
a financial account;
a redemption account;
a stored value account;
a gift card account;
a credit card account;
a debit card account; and
a prepaid telephone account.

5. The computer-implemented method of claim 4, wherein the specified DID telephone number is associated with an Automatic Teller Machine (ATM) transaction and the payee is a user of the ATM.

6. The computer-implemented method of claim 1, wherein the payee is not identified.

7. The computer-implemented method of claim 1, further comprising:
sending a transaction reference number to a specific network address of the payee.

8. The computer-implemented method of claim 1, wherein the specified DID telephone number is associated with a person-to-person transaction and the payee is a different person than the payor.

9. The computer-implemented method of claim 1, wherein the specified DID telephone number is associated with a merchant transaction and the payee is a merchant.

10. The computer-implemented method of claim 1, wherein the specified DID telephone number is associated with a transaction for a vending machine and the payee is an operator of the vending machine.

11. The computer-implemented method of claim 1, wherein the specified DID telephone number is associated with a transaction for a Point-Of-Sale (POS) terminal and the payee is an operator of the POS terminal.

12. The computer-implemented method of claim 1, wherein the transaction code is valid only for a specified period.

13. The computer-implemented method of claim 11, wherein the specified period the transaction code is valid is set by at least one of the payor and the financial transaction server.

14. The computer-implemented method of claim 1, wherein the designator of value is one of money, coupons, vouchers, tokens, points, stamps and marketable commodity.

15. The computer-implemented method of claim 1, wherein the designator of value is in a first national currency; and the method further comprising.
converting the first national currency to a second national currency; and
wherein the re-assigning the designator of the value to the payee includes the value in the second national currency.

16. The computer-implemented method of claim 2, wherein the transaction code is provided to the payee with a transposition cipher selected from a group of transposition ciphers consisting of route cipher, columnar transposition cipher, double transposition cipher, substitution cipher, and addition cipher, whereby prior to use by the payee, the transaction code must be decrypted.

17. The computer-implemented method of claim 3, wherein the transaction code is provided to the payee with a transposition cipher selected from a group of transposition ciphers consisting of route transposition cipher, columnar transposition cipher, double transposition cipher, substitution cipher, and addition cipher, whereby prior to use by the payee, the transaction code must be decrypted.

18. The computer-implemented method of claim 2, further comprising:
receiving a message from the payor for the payee;
sending the at least one transaction code to the payee with the message from the payor.

19. The computer-implemented method of claim 3, further comprising:
receiving a message from the payor for the payee;
sending the at least one transaction code to the payee with the message from the payor.

20. A computer-implemented method of conducting a financial transaction, the method on a financial transaction server comprising:
receiving using a Voice Over IP (VoIP) platform at a specified Direct Inward Dial (DID) telephone number associated with an Automatic Teller Machine (ATM) transaction from a telephone call from a user wishing to receive a quantity of a marketable commodity from a designated ATM;
receiving a signal that a given transaction code is entered by the user of the ATM; and
sending a notification message over a network for the ATM to dispense the quantity of the marketable commodity in response to receiving the signal.

21. The computer-implemented method of claim 20, wherein the marketable commodity is at least one of:
cash;
a coupon;
a voucher;
a stamp;
a ticket;
a token;
a point; and
a redeemable tangible medium with immediate inherent value.

22. The computer-implemented method of claim 20, wherein the receiving a signal that the given transaction code is entered by the user at the ATM includes checking if the Automatic Number Identifier of a wireless handset for the user calling the DID telephone number is authorized.

23. The computer-implemented method of claim 20, wherein the specified Direct Inward Dial (DID) telephone number is associated only with the designated ATM.

24. The computer-implemented method of claim 20, wherein the specified Direct Inward Dial (DID) telephone number is associated only with the network for the ATM.

25. The computer-implemented method of claim 20, wherein the quantity of marketable commodity is dispensed in response to a transaction code being entered into the ATM by the user.

26. The computer-implemented method of claim 25, wherein the quantity of marketable commodity is dispensed at the ATM in response to the transaction code and a telephone number of the wireless handset being entered into the ATM.

27. The computer-implemented method of claim 25, wherein the user of the ATM receives the transaction code from a third party payor of the quantity of marketable commodity by means separate from the ATM and the ATM network.

28. The computer-implemented method of claim 27, wherein the user of the ATM receives the transaction code from a third party payor of the quantity of marketable commodity through at least one of:
a text message;
a voice message;
an e-mail message;
a fax;
a telegram; and
a postal letter.

29. The computer-implemented method of claim 20, wherein the sending the notification message over a network for the ATM using a Voice Over IP (VoIP) protocol includes sending a notification to a payment processor that is associated with the ATM network.

30. The computer-implemented method of claim 20, wherein the sending the notification message over a network for the ATM using a Voice Over IP (VoIP) protocol includes selecting one of a plurality of payment processors (e.g. First Data, HSBC), based on a fee charged by the payment processor.

31. The computer-implemented method of claim 21, wherein the fee charged by the payment processor is one of an exchange rate, an interchange rate and an authentication type provided by the user.

32. The computer-implemented method of claim 20, wherein the sending the notification message over a network for the ATM using a Voice Over IP (VoIP) protocol includes selecting one of a plurality of ATM operators (e.g. First Data, HSBC), based on a fee charged by the payment processor.

33. The computer-implemented method of claim 20, wherein the quantity of a marketable commodity from the designated ATM is in a national currency that is different from a national currency used to originally fund the quantity of marketable commodity.

34. The computer-implemented method of claim 20, wherein the user of the ATM is different from a person that originally funded the quantity of marketable commodity.

35. A computer-implemented method of conducting a financial transaction, the method on a financial transaction server comprising:
assigning, using a preauthorization by a payor associated with an authorized payor telephone identifier, a designator of a value for a subsequent transaction between the payor and at least one payee;
receiving at a specified Direct Inward Dial (DID) telephone number associated with a transaction type a telephone call with the authorized payor telephone identifier;
in response to receiving the telephone call, re-assigning the designator of the value to a payee; automatically calling the payee to deliver information regarding the re-assigning of the designator of value; and
receiving a response from the payee that the information was received.
